(19) United States
(12) Patent Application Publication
(10) Pub. No.: US 2006/0143093 A1
(43) Pub. Date: Jun. 29, 2006

(54) Predictive user interface system

(76) Inventors: Samuel I. Brandt, Malvern, PA (US); Jan DeHaan, Downington, PA (US); John D. Haley, Honey Brook, PA (US); Zhijing Liu, Audubon, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/285,807

(22) Filed: Nov. 23, 2005

Related U.S. Application Data
(60) Provisional application No. 60/630,759, filed on Nov. 24, 2004.
(60) Provisional application No. 60/630,755, filed on Nov. 24, 2004.

(51) Int. Cl. G06Q 30/00; G07G 1/00; G06Q 10/00

(52) U.S. Cl. 705/26; 705/2; 705/10

(57) ABSTRACT

A user interface system decreases the number of user interactions with a computer user interface, used to select items in multiple related menus, through a comprehensive heuristic menu arrangement control by providing several discrete, yet complementary, features. The system enables user selection of related parameters identifying an order for providing an item. A repository includes information identifying candidate items for order and associated corresponding related order parameters. An individual item for order is associated with multiple related order parameters. A user interface processor provides data representing a display image identifying an initial complete candidate order including multiple related parameters, in response to user entry of order-associated data. In response to user selection of an individual parameter of the initial complete candidate order, the user interface processor provides data representing multiple, different individually user selectable complete candidate orders incorporating corresponding sets of different related order parameters. The complete candidate orders are derived using the repository and based on user ordering history. The user interface processor selects one of the multiple, different individually user selectable complete candidate orders in response to a user command.

### CROSS-REFERENCE TO RELATED APPLICATIONS

The present application is a non-provisional application of provisional application having Ser. No. 60/630,759 and provisional application having Ser. No. 60/630,755, each filed by Samuel I. Brandt, et al. on Nov. 24, 2004.

### FIELD OF THE INVENTION

The present invention generally relates to computer systems. More particularly, the present invention relates to a computer system having a predictive user interface system enabling user selection of related parameters identifying an order for providing an item.

### BACKGROUND OF THE INVENTION

A computer system is a device or machine for processing information from data according to a software program, otherwise called a computer application, which is a compiled list of instructions. The information to be processed may represent numbers, text, pictures, or sound, amongst many other types.

Prior computer systems and applications facilitate computer data entry by replacing the need to enter characters one at the time with the ability to select the desired data from lists or menus of expected values, and further seek to optimize user interaction with individual menus.

For example, U.S. Pat. No. 6,583,797 entitled “Menu Management Mechanism That Displays Menu Items Based On Multiple Heuristic Factors” provides an overview of such prior systems. However, even with the prior systems' attempt to minimize a user's effort to enter data, the number of user interactions, such as pointer (e.g., mouse) movement, menu selection and menu item selection, can be considerable.

In prior physician order entry or clinical documentation systems for ordering treatments for a patient, a physician or worker is presented with a large number of available selections. Additionally, physician orders and clinical documentation frequently require the insertion of values for multiple attributes within an order or documentation phrase. This type of system results in a combinatorial explosion of potential selection choices for the user.

Prior systems attempt to solve this particular challenge through a number of different means, each of which is not adequate. One solution is to provide rigid predefined order sentences, which represent constellations of common attribute value pairs. This solution forces the user to suffer increased reading load by having to select between multiple pre-configured constellations of attribute value pairs. For example, a user would have to pick from among the following attribute value constellations for “amoxicillin.”

Amoxicillin 500 mg; one by mouth every eight hours times 10 days.

Amoxicillin 500 mg; one by mouth every eight hours times seven days.

Amoxicillin 500 mg; two by mouth every eight hours times 10 days.

Amoxicillin 500 mg; two by mouth every 12 hours times 10 days.

Amoxicillin 500 mg two by mouth every 12 hours times seven days.

Amoxicillin 250 mg; one by mouth every eight hours times 10 days.

Amoxicillin 250 mg; one by mouth every eight hours times seven days.

Amoxicillin 250 mg one by mouth every 12 hours times 10 days.

Another solution is to provide menu screens, which treat each attribute as independent. In this case, the user experiences much less reading load, but has to navigate through multiple selections, and has the potential of creating nonsensical or unlikely combinations. For example, in this case, the user clicks on four independent attribute value selections.

In prior non-computerized systems, a piece of paper for manual user note taking (e.g., a “script”) provided a simple interface, which permitted the physician to record phrases composed of entry value pairs correctly, without significant reading load or navigation. However, manual note taking is time consuming and prone to error.

Computerized physician order entry systems have had a difficult time matching the speed and user acceptance of the manual paper entry. Clinical information systems attempt to sell physician order entry based on its improvement in inpatient safety and in transcription errors to justify the increased time and effort required by the physician.

The prior systems fail to optimize a user's interaction with a computer display involving multiple menu selections. A system according to invention principles addresses these deficiencies and related problems.

### SUMMARY OF THE INVENTION

A user interface system, providing an automatic menu arrangement for both fixed and variable content menus, combines items from multiple menus into a single extended menu, such that user selection of an extended menu item results in the concurrent selection of items in multiple menus. The system 100 enables user selection of related parameters identifying an order for providing an item. A repository includes information identifying candidate items for order and associated corresponding related order parameters. An individual item for order is associated with multiple related order parameters. A user interface processor provides data representing a display image identifying an initial complete candidate order including multiple related parameters, in response to user entry of order-associated data. In response to user selection of an individual parameter of the initial complete candidate order, the user interface processor provides data representing multiple, different individually user selectable complete candidate orders incorporating corresponding sets of different related order parameters. The complete candidate orders are derived using the repository and based on user ordering history. The user interface processor selects one of the multiple, different individually user selectable complete candidate orders in response to a user command.

### BRIEF DESCRIPTION OF THE DRAWINGS

FIG. 1 illustrates a user interface system, in accordance with invention principles.

FIG. 2 illustrates system architecture for the user interface system, as shown in FIG. 1, in accordance with invention principles.

FIG. 3 illustrates a method for the system architecture, as shown in FIG. 2, and the user interface system, as shown in FIG. 1, in accordance with invention principles.

FIG. 4 illustrates user interface display of an order for an item, in accordance with invention principles.

FIG. 5 illustrates user interface display providing a decision tree for the order of the item, in accordance with invention principles.

FIG. 6 illustrates user interface display providing a decision tree for an order of an item, in accordance with invention principles.

### DETAILED DESCRIPTION OF THE PREFERRED EMBODIMENTS

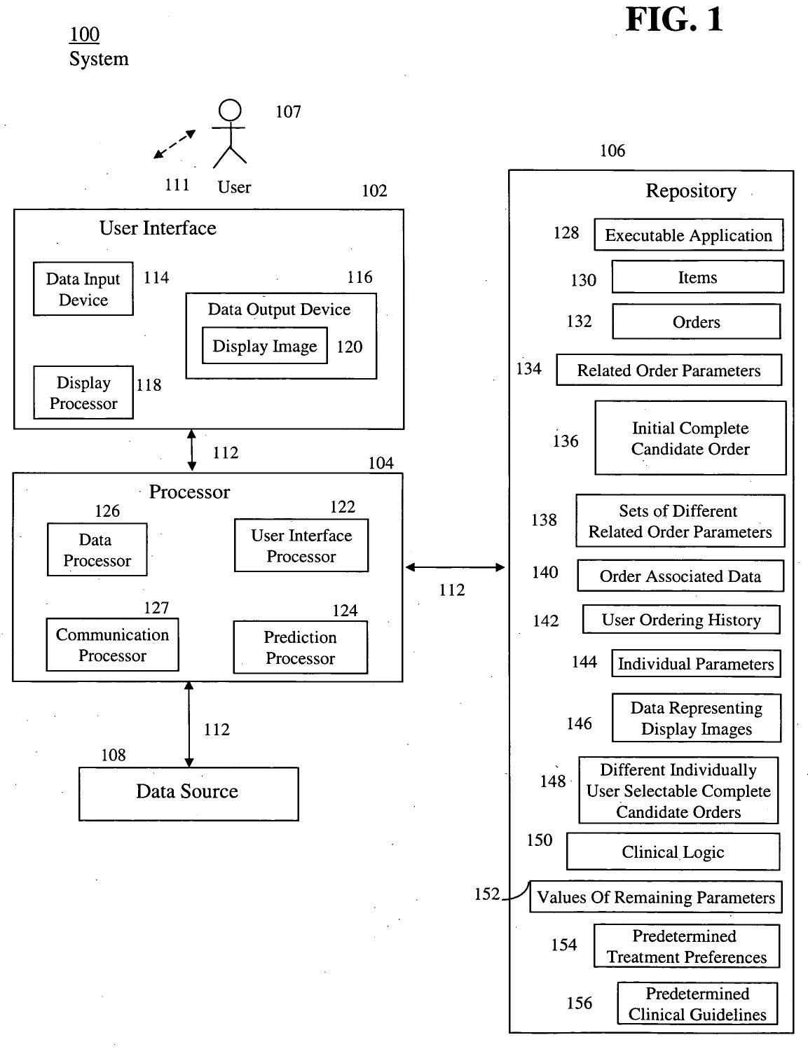

FIG. 1 illustrates a user interface system (i.e., “system”). The system 100 includes a user interface 102, a processor 104, and a repository 106. A user 107 and a data source 108 interact with the system 100.

A communication path 112 interconnects elements of the system 100, and/or interconnects the system 100 with the data source 108. The dotted line near reference number 111 represents interaction between the user 107 and the user interface 102.

The user interface 102 further provides a data input device 114, a data output device 116, and a display processor 118. The data output device 116 further provides one or more display images 120, which are presented for viewing by the user 107.

The processor 104 further includes a user interface processor 122, a prediction processor 124, a data processor 126, and a communication processor 127.

The repository 106 further includes an executable application 128, items 130, orders 132, related order parameters 134, an initial complete candidate order 136, sets of different related order parameters 138, order associated data 140, user ordering history 142, individual parameters 144, data representing display images 146, different individually user selectable complete candidate orders 148, clinical logic 150, values of remaining parameters 152, predetermined treatment preferences 154, and predetermined clinical guidelines 156.

The data source 108 represents a source of any information that may be needed or used by the system 100 including, for example, any of the information stored in the repository 106. The information may be pushed to the system 100 and/or pulled by the system 100, automatically and/or manually, at one time, periodically, or as needed.

The system 100 may be employed by any type of enterprise, organization, or department, such as, for example, providers of healthcare products and/or services responsible for servicing the health and/or welfare of people in its care. For example, the system 100 represents a healthcare information system. A healthcare provider provides services directed to the mental, emotional, or physical well being of a patient. Examples of healthcare providers include a hospital, a nursing home, an assisted living care arrangement, a home health care arrangement, a hospice arrangement, a critical care arrangement, a health care clinic, a physical therapy clinic, a chiropractic clinic, a medical supplier, a pharmacy, a doctor's office, and a dental office. When servicing a person in its care, a healthcare provider diagnoses a condition or disease, and recommends a course of treatment to cure the condition, if such treatment exists, or provides preventative healthcare services. Examples of the people being serviced by a healthcare provider include a patient, a resident, a client, and an individual.

The system 100 may be fixed and/or mobile (i.e., portable). The system 100 may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch.

The system 100 and/or elements contained therein also may be implemented in a centralized or decentralized configuration. The system 100 may be implemented as a client-server, web-based, or stand-alone configuration. In the case of the client-server or web-based configurations, the executable application 128 may be accessed remotely over a communication network.

The communication path 112 (otherwise called network, bus, link, connection, channel, etc.) represents any type of protocol or data format. The protocol or data format includes, but is not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application, for example.

The data input device 114 typically provides data to a processor in response to receiving input data either manually from a user or automatically from another electronic device. For manual input, the data input device is a keyboard and a mouse, but also may be a touch screen, or a microphone and a voice recognition application, for example.

The data output device 116 typically provides data from a processor for use by a user or another electronic device. For output to a user, the data output device 116 is a display, such as, a computer monitor or screen, that generates one or more display images 120 in response to receiving the display signals from the display processor 118, but also may be a. speaker or a printer, for example.

The display processor 118 (e.g., a display generator) includes electronic circuitry or software or a combination of both for generating the display images 120 or portions thereof in response to receiving data representing display images 146, which are stored in the repository 106. The data output device 116, implemented as a display, is coupled to the display processor 118 and displays the generated display images 120. The display images 120 provide, for example, a graphical user interface, permitting user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

The user interface processor 122 and the prediction processor 124 perform specific functions for the system 100, as explained in further detail herein below. The data processor 126 performs other general data processing for the system 100. The communication processor 127 manages communications within the system 100 and outside the system 100, such as, for example, with the data source 108.

The repository 106 represents any type of storage device, such as computer memory devices or other tangible storage medium, for example. The repository 106 may be implemented as a database, for example. The repository 106 represents one or more memory devices, located at one or more locations, and implemented as one or more technologies, depending on the particular implementation of the system 100.

An executable application, such as the executable application 128, comprises machine code or machine readable instruction for implementing predetermined functions including, for example, those of an operating system, a software application program, a healthcare information system, or other information processing system, for example, in response user command or input.

An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters.

A calling procedure is a procedure for enabling execution of another procedure in response to a received command or instruction. An object comprises a grouping of data and/or executable instructions or an executable procedure.

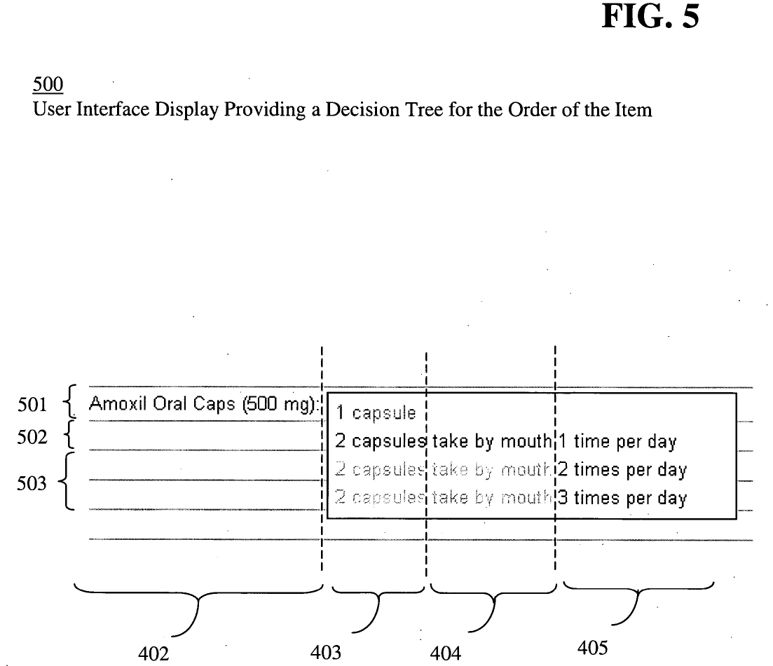

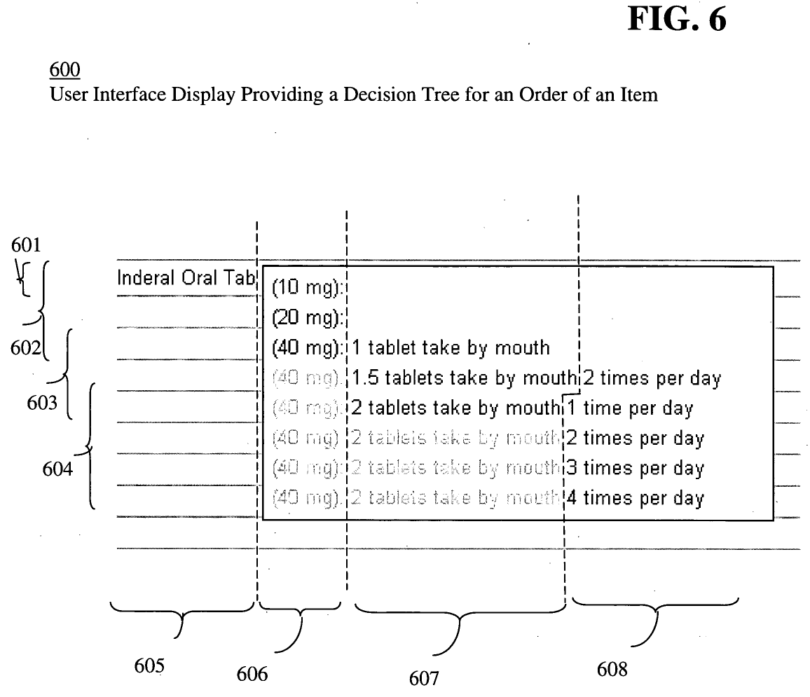

The system 100 provides a computer user interface 102 that involves the user 107 specifying the value of multiple attributes, otherwise called parameters, through menu selections, as shown in FIGS. 5 and 6, for example. The attribute values may represent selection criteria for computerized data retrieval, represent values to be stored in the repository 106, or may represent parameters for other computerized functions.

The system 100 automatically increases the number of menu items in short menus by combining one or more items in a short menu with items in one or more other related menus, such that a single selection of a combined item in the extended menu results in simultaneous selection of items in multiple related menus.

The system 100 uses heuristics to determine which combination of menu items should be represented in the extended menu. Heuristics are used when the number of possible combinations of menu items in related menus is so large that time and system resources required to generate and navigate that extended menu negate the benefits of being able to select items in multiple menus with a single selection in an extended menu.

In computer science, heuristics relates to or using a problem-solving technique in which an appropriate solution of several found by alternative methods is selected at successive stages of a program for use in the next step of the program. A heuristic is a function, h(n), defined on the nodes of a search tree, which serves as an estimate of the cost of the optimal path from that node to the goal node. Another heuristic is a function, h2 (n), defined on the end nodes of a search tree, which serves as an estimate of the utility of a path from root to end node.

The system 100 heuristically minimizes the time required for multi-menu based data entry by considering total user task load. The total user task load is the total time the system 100 needs to generate and render the content of a menu and the total number of user system interactions needed to operate the user interface and the user reading load. User operations of the user interface 102 include, for example, scrolling menus, moving the pointing device to other menus, selecting and displaying the content of those menus, moving the pointing device to the menu items, and clicking on choices.

This system 100 increases the speed with which a user 107 can specify multiple attributes used by the computer application 128. In data entry applications that allow the data to be entered through menu selections, this speed increase is significant. For example, consider an order entry application that uses on average the specification of four attributes per order. If the heuristics of the system 100 allow: four attribute values to be specified with a single selection of a combined item in an extended menu 50% of the time, two selections of combinations of two attributes in two extended menus 25% of the time, and four selections of four attributes 25% of the time, then, on average, one order can be specified with a total of four user interactions. By comparison, prior systems on average use eight user interactions for the same task.

The heuristics take into account the likelihood that a particular combination of menu items is selected, the reading load that may be experienced by a user 107 when trying to locate the desired menu items, and the time and effort required to scroll large menus, to open multiple menus and to locate and select desired items in those menus.

The system 100 utilizes a decision tree structure, otherwise called a search tree, for example, as shown in FIGS. 5 and 6, for example, that organizes attributes into nested nodes within the decision tree. Appropriate values are associated with each attribute, in the context of its parent attribute values. A node is assigned frequencies or probabilities, based upon global, group, and independent historical ordering frequencies. This permits the retrieval of probability ordered attribute values for any unvalued attributes in an order phrase, based upon the values already selected for value attributes.

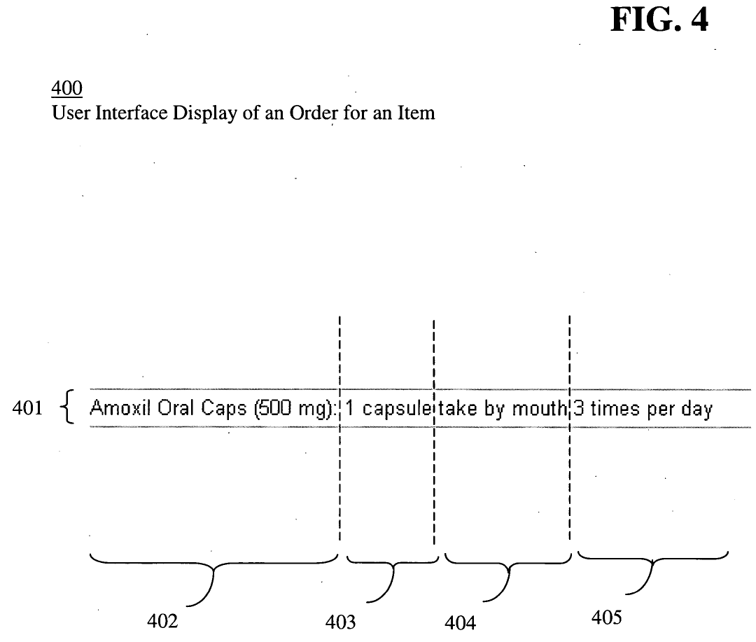

The system 100 decreases the number of user interactions between the user 107 and the user interface 102, used to select items in multiple related menus, through a comprehensive heuristic menu arrangement control by providing several discrete, yet complementary, features. An automatic menu arrangement for both fixed and variable content menus is based on combining items from multiple menus into a single extended menu such that the selection of an extended menu item results in the concurrent selection of items in multiple menus. The system 100 uses data indicating combination of frequency of selection and recentness of selection. The system 100 permits the consideration of attributes of a combination of contexts in which the menu is presently used. The system 100 advantageously reduces the number of user interactions required to select items from multiple related menus. The system 100 enables user selection of related parameters identifying an order 132, as shown in FIG. 4, for providing an item 130. The repository 106 includes information identifying candidate items 130 for order and associated corresponding related order parameters 134. An individual item for order is associated with multiple related order parameters. The user interface processor 122 provides data representing a display image 120 identifying an initial complete candidate order 136 including multiple related parameters, in response to user entry of order-associated data 140. In response to user selection of an individual parameter 144 of the initial complete candidate order 136, the user interface processor 122 provides data representing multiple, different individually user selectable complete candidate orders 148 incorporating corresponding sets of different related order parameters. The complete candidate orders are derived using the repository 106 and based on user ordering history 142. The user interface processor 122 selects one of the multiple, different individually user selectable complete candidate orders 148 in response to a user command 111.

The phrase “complete candidate order” as referred to with the initial complete candidate order 136 and/or the multiple, different individually user selectable complete candidate orders 148, for example, comprises full or partial candidate orders, as shown in FIGS. 5 and 6, for example.

The phrase “initial complete candidate order” 136 applies not only to the first complete candidate order, but also to any complete candidate order that the system generates after each user selection of a menu item.

An order 132 comprises any type of request, statement, phrase, input, etc. including, for example, a clinical order and/or clinical documentation.

The item 130 comprises any type of product and/or service. Examples of clinical products include, for example, drugs, equipment, etc. Examples of clinical services include, for example, therapeutic services, diagnostic services, clinical consulting services, surgical procedures, nursing services, counseling services, observation services, treatment, drug administration services, etc.

The user ordering history 142 comprises, for example, any person, anywhere, any time that has ordered an item in the past. In other words, “user” comprises, for example, the present user 107, a single user, a predetermined group of users, users in a specific department, users in an institution (e.g., hospital), users in an industry (e.g., medical), etc.

The initial complete candidate order 136 is a single order. By example, the orders 132 are orders for providing medical treatment (e.g., administering a drug) for a patient and the related parameters identify at one or more of the following: (a) quantity, (b) a route of administration of a medical treatment, (c) a frequency of administering a treatment, and (d) a form of medical treatment.

The form of medical treatment includes one or more of the following: (a) a package type, (b) a strength of a medical treatment, and (c) a concentration of a medical treatment.

The prediction processor 124 predicts values of remaining parameters 152 of an individual order, in response to user selection of a value of an individual parameter 144 of the initial complete candidate order 136.

The prediction processor 124 predicts values of remaining parameters 152 related to an individual order based one or more of the following: (a) user ordering history 142, and (b) clinical logic 150, for example. The clinical logic 150 employs one or more of the following: (a) Bayesian logic, (b) Hidden Markov Models, (c) neural networks, and (d) fuzzy logic, for example.

The prediction processor 124 predicts values of remaining parameters 152 of an individual order in response to a user selected value of a parameter of the individual order. The user-selected value of the parameter of the individual order constrains a set of allowable values of the remaining parameters of the individual order.

The prediction processor 124 predicts and incorporates values in the different related order parameters of the multiple, different individually user selectable complete candidate orders 148, in response to user selection of a value of an individual parameter 152 of the initial complete candidate order 136.

The prediction processor 124 predicts values of remaining parameters 152 of an individual order based on one or more of the following: (a) user ordering history 142, and (b) clinical logic 150, for example.

Specifically, the prediction processor 124 predicts values of remaining parameters 152 of an individual order in response to a user-selected value of a parameter of the individual order. The user-selected value of the parameter of the individual order constrains a set of allowable values of the remaining parameters of the individual order.

The initial complete candidate order 136 is derived by identifying an order 132 having the highest probability of being desired by the user 107 based on user prior ordering history 142 and received medical information of the patient concerned using the repository.

The initial complete candidate order 136 is derived based on one or more of the following: (a) predetermined clinical guidelines 156, (b) predetermined departmental treatment preferences 154, and (c) treatment resource availability, for example.

The prediction processor 124 determines a number of the multiple; different individually user-selectable complete candidate orders 148 identified in the display image 120 in response to a determined user task load.

The prediction processor 124 determines a number of the multiple, different individually user selectable complete candidate orders 148 identified in a display image in response to one or more of the following three estimates. An estimated time required to generate and render an image menu incorporating data identifying the multiple different individually user selectable complete candidate orders 148. An estimated number of system interactions required to scroll the image menu incorporating data identifying the multiple different individually user selectable complete candidate orders 148. An estimated time required to select and display the image menu incorporating data identifying the multiple different individually user selectable complete candidate orders 148.

The prediction processor 124 predicts one or more of the following: (a) the initial complete candidate, and (b) the multiple, different individually user selectable complete candidate orders 148, based on user entered text partially identifying an order 132.

The user interface processor 122, in response to user selection of an individual parameter value of the initial complete candidate order 136, provides data representing multiple different individually user-selectable partial candidate orders incorporating corresponding sets of different related order parameters. The partial candidate orders are derived using the repository 106, and based on user ordering history 142 and the partial candidate orders, in combination with the user-selected individual parameter value, comprise complete candidate orders. The prediction processor 124 predicts values of remaining parameters of the partial candidate orders. The user-selected value of the individual parameter remains fixed.

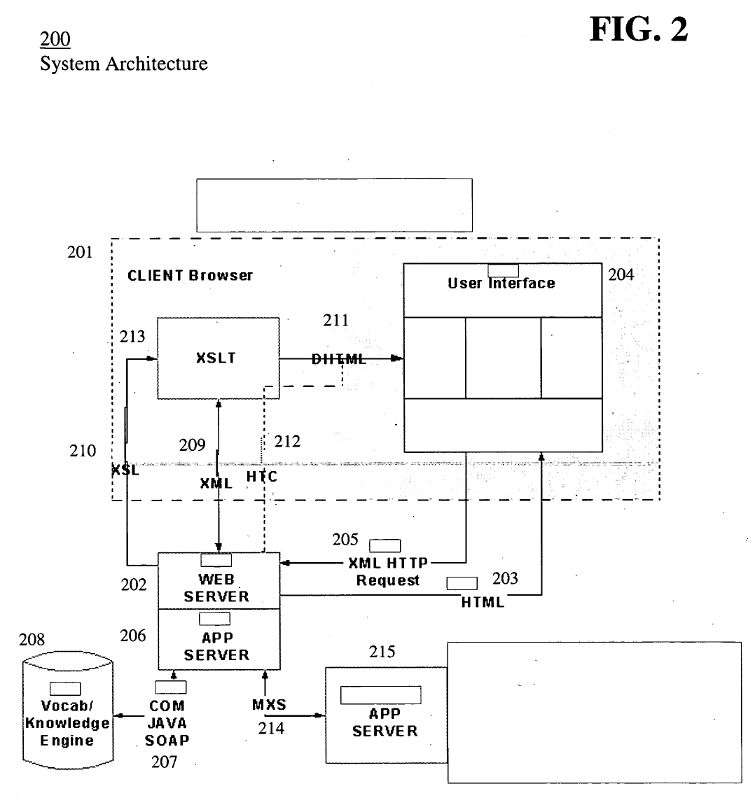

FIG. 2 illustrates system architecture 200 for the user interface system 100, as shown in FIG. 1. The system architecture 200 is implemented as client-server system architecture, for example. The system architecture 200 includes a Client browser 201, a Web server 202, a user interface 204 (also referenced as 102 in FIG. 1), an application server (App Server) 206, a vocabulary/knowledge engine (i.e., server) 208, and an eXtensible Stylesheet Language (XSL) Transformation (XSLT) 213.

The Client browser 201 includes the user interface 204 and the XSLT 213.

The Web server 202 comprises either a computer that is responsible for accepting HTTP requests from clients, which are known as web browsers, and serving them web pages, which are usually HTML documents, or comprises computer program that provides the functionality of the computer. The Web server 202 is encompassed within the processor 104, as shown in FIG. 1.

The Application Server 206 is a server computer in a computer network dedicated to running certain software applications, such as those stored in the Vocabulary/Knowledge engine 208 or the Application Server 215, via Message eXchange Service (MXS) 214 (a proprietary service), for example. The term also refers to the software installed on such a computer to facilitate the serving (i.e., running) of other applications. The processor 104, as shown in FIG. 1, encompasses the Application Server 206.

The Vocabulary/Knowledge engine 208 is a software application that provides all or a portion of the information stored in the repository 106, as shown in FIG. 1. Hence, the Vocabulary/Knowledge engine 208 is encompassed within the data source 108 and/or the repository, in combination with the processor 104, as shown in FIG. 1.

The XSLT 213 is an Extensible Markup Language (XML)-based language used for the transformation of XML documents. The original document is not changed; rather, a new XML document is created based on the content of an existing document. The new document may be serialized (output) by the processor in standard XML syntax or in another format, such as HTML or plain text. XSLT is often used to convert data between different XML schemas or to convert XML data into web pages or Portable Document Format (PDF) documents. The XSLT 213 represents the display processor 118 and/or the processor 104, as shown in FIG. 1.

The eXtensible Stylesheet Language (XSL) is a family of programming languages which allows one to describe how files encoded in the Extensible Markup Language (XML) standard are to be formatted or transformed. A language in the family of programming languages includes XSL Transformations, which is an XML language for transforming XML documents.

The Extensible Markup Language (XML) is a World Wide Web Consortium (W3C)-recommended general-purpose markup language for creating special-purpose markup languages. XML is a simplified subset of Standard Generalized Markup Language (SGML), capable of describing many different kinds of data. XML's primary purpose is to facilitate the sharing of data across different systems, particularly systems connected via the Internet. Languages based on XML are defined in a formal way, allowing software programs to modify and validate documents in these languages, without prior knowledge of their form.

In the system 100, the decision tree, referenced as 501-503 in FIG. 5 and 601-604 in FIG. 6, for example, is provided to the Client's Browser 201 as XML 209. An XSL transform 213 is used to create Dynamic HTML (DHTML) 211 user interface elements including menus. Rule-based logic 150 (FIG. 1) is provided to the Client's Browser 201 through the association of HTML Components (HTC's), for example, based upon specific-data attribute values.

HTCs are an implementation of rules for Microsoft Internet Explorer® browser that provide a mechanism to implement components in script as Dynamic HTML (DHTML) behaviors. Saved with an extension “.htc,” an HTC is an HTML file that contains script and a set of HTC-specific elements that define the component. An alternative to HTCs includes, for example, regular JavaScript scripts.

DHTML creates interactive web sites by using a combination of static markup language HTML, a client-side scripting language (e.g., Javascript), and the presentation definition language Cascading Style Sheets (i.e., a stylesheet language used to describe the presentation of a document written in a markup language) and the Document Object Model (i.e., an application programming interface to access HTML and XML documents). DHTML may be used to create applications in a web browser, for example, to ease navigation or to create interactive forms.

The decision tree may include many (e.g., tens, hundreds, thousands, etc.) of potential attribute value combinations within the construction of a phrase. The rule-based logic 150 in combination with the user interface 204 permits the user 107 to navigate the decision tree in order to create aggregated menu selections that balance reading load with navigation load.

Although the attribute values are represented as a hierarchical decision tree, it is possible to fix attribute values in any order, and at any level, and still retrieve heuristics, as explained herein, for unvalued attributes. Hence, the system 100 may employ various methods of presenting the attribute values and is not limited to a hierarchical decision tree.

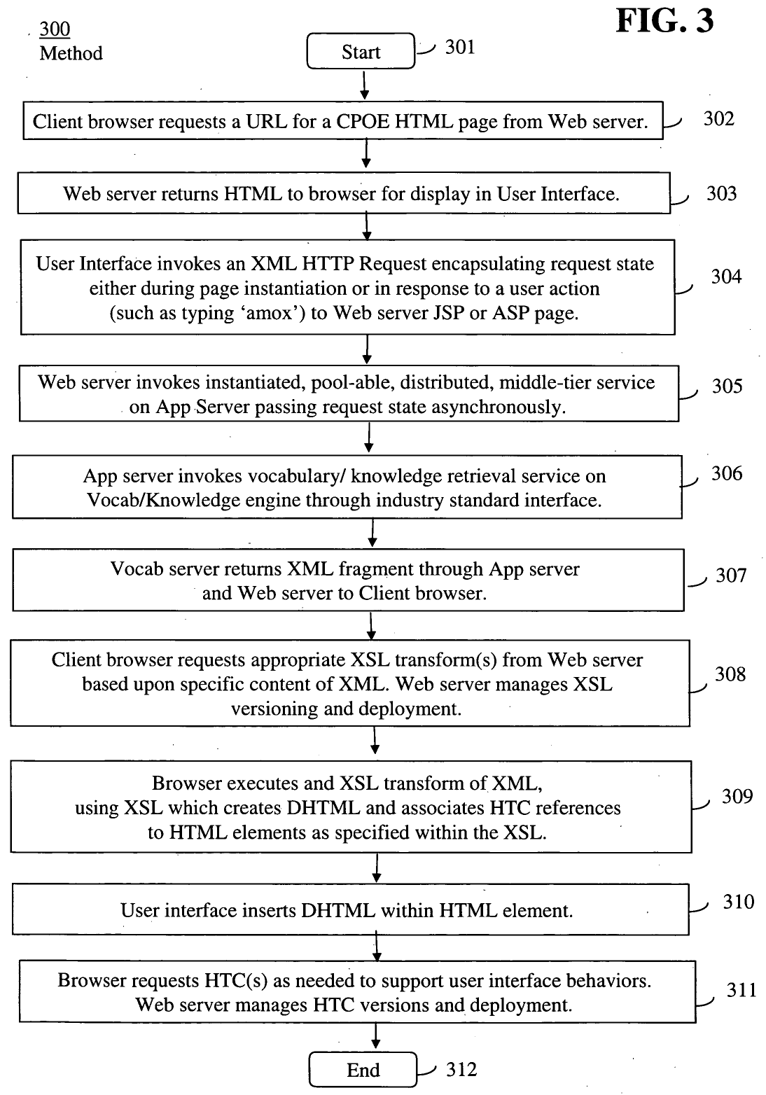

FIG. 3 illustrates a method 300 for the system architecture 200, as shown in FIG. 2, and the user interface system 100, as shown in FIG. 1.

At step 301, the method starts.

At step 302, the Client Browser 201 uses a Universal Resource Locator (URL) to retrieve a Hyper Text Markup Language (HTML) page from Web server 202. The HTML page may be a Computerized Physician Order Entry (CPOE) page provided as a display image 120 on the display 116, for example.

At step 303, the Web server 202 returns HTML 203 to the Client Browser 201 for display in the User Interface 204, via DHTML 211 received from the XSL transformer 213.

At step 304, the User Interface 204 invokes an XML Hyper Text Transmission Protocol (HTTP) request 205, encapsulating request state, either during page instantiation or in response to a user command (e.g., such as typing “amox”) sent to the Web server 203, via a Java Server Page (JSP) or an Application Server Page (ASP) data entry, for example. In programming, instantiation is the creation of a real instance or particular realization of an abstraction or template, such as a class of objects or a computer process.

At step 305, the Web server 202 invokes instantiated, pool-able, distributed, middle-tier service on the Application Server 206 passing the request state asynchronously.

At step 306, the Application server 206 invokes a vocabulary/knowledge retrieval service on the Vocab/Knowledge engine 208, through an industry standard interface 207, such as Component Object Model (COM), JAVA, or Simple Object Access Protocol (SOAP), for example.

At step 307, the Vocabulary/knowledge server 208 returns XML fragment 209 through the Application server 206 and the Web server 202 to the Client Browser 201.

At step 308, the Client browser 201 requests appropriate XSL 210 from the Web server 202 based upon specific content of the XML 209. Web server 202 manages the XSL versioning and deployment.

At step 309, the Client Browser 201 executes an XSL transform of XML 209, using XSL 210, which creates the DHTML 211 and associates the HTC references to HTML elements as specified within the XSL 210.

At step 310, the User Interface 204 inserts DHTML 211 within the HTML element 204.

At step 311, the Client Browser 201 requests the HTC(s) 212, as needed, to support user interface behaviors. The Web server 202 manages the HTC versions and deployment.

At step 312, the method ends.

FIG. 4 illustrates user interface display 400 of an order 132 for an item 130. The system 100 displays the order 132 as “Amoxil Oral Caps (500 mg): 1 capsule take by mouth 3 times per day.”

Upon the user selection of a search term, such as “amoxicillin oral,” for example, the Vocabulary/knowledge engine 208 retrieves a hierarchical decision tree that embeds multiple attributes 402-405 and their associated values for the construction of an order 132 for “amoxicillin.”

A single order phrase, such as that for “amoxicillin,” for example, includes multiple attributes 402-405, which are discreetly valued. For example, 500 mg is one of several strengths for “amoxicillin” capsules. A dose can consist of one or more capsules. The capsules can be taken orally, or maybe inserted through an enteric tube. The capsules may be administered three times a day, or at other intervals. Additionally, adjunctive orders may be associated with the order 132, such as “with food,” or “when awake,” etc. There are literally hundreds of permutations of attribute value constellations, which can be formulated for “amoxicillin” oral capsules, or any other search term.

FIG. 5 illustrates user interface display 500 providing a decision tree 501-503 for the order 132 of the item 130.

The system 100 provides the ability to programmatically traverse the decision tree 501-503, and to examine unvalued attributes 402-405, and make heuristic decisions regarding whether attributes 402-405 can be concatenated selection choices, which can be selected by the user with a single click avoiding the need for serial selection from cascading lists. By contrast, prior systems require that the user select each attribute in sequence, and select from a list of appropriate values.

For example, the user 107 clicks on one capsule in decision tree branch 501 under attribute 403. Rather than simply offering the user a choice of quantities of capsules, the system 100 recognizes that the high probability selections for amoxicillin 500 mg capsules, in decision tree branch 501 under attribute 402, include either one capsule or two capsules, as shown under attribute 403. Since the value was already one capsule, the system 100 assumes that the user 107 would want two capsules, as shown in decision tree branch 502 under attribute 403. The system 100 recognizes that the user 107 would be faced with subsequent choices for route (e.g., “take by mouth”), under attribute 404, and for frequency (e.g., “1 time per day”), under attribute 405. The system 100, using the prediction processor 124, computes that the subsequent choices can be condensed into three choices, which include the quantity of capsules, under attribute 403, the route, under attribute 404, and frequency, under attribute 405. The user is able to make a completed order configuration with just one click and subsequent dragging of a mouse pointer to the desired combination of attributes 403-405 in the decision tree 501-503.

FIG. 6 illustrates user interface display 600 providing a decision tree 601-604 for various attributes 605-608 of an order 132 of an item 130. The system 100 provides a “telescoping” function, for example, for future menu choices.

The system 100 mixes levels of concatenation or cascading (e.g., overlaps in a telescoping function) in the decision tree 601-604, in order to provide an efficient way for the user 107 to navigate the menu of choices available.

The system 100, using the prediction processor 124, performs the telescoping function by examining probable subsequent choices, and by determining the number of permutations that are likely to be needed. The system 100 calculates effective choices to include in the list, based on probable hit rate of the desired order. The total number of selections within the list is constrained by a configurable parameter.

In the example shown in FIG. 6, the user 107 is permitted to select 10 or 20 mg strengths, under attribute 606, and is permitted to subsequently select other parameters, under attributes 607 and 608. The various other decision tree selections for 40 mg capsules are pre-concatenated.

Note that if the user clicks one tablet, under attribute 607 in decision tree branch 602/603, a subsequent choice of frequency may be necessary for the user to select. However, for 1.5 and 2 tablets, the probable frequency choices are listed, as shown in FIG. 6, for example.

The system 100 is especially beneficial in medical computerized systems supporting physician order entry processes, as shown and described herein. However, the system 100 is applicable to a wide variety of menu based data entry systems, and not just the user interface displays developed for healthcare, as shown in FIGS. 4-6. Any type of user interface display, menu choice layout, design, selection, function, etc. may be used to support any type of selection from any type of user. The system 100 is applicable for use in any type of data entry process that uses multiple menus to permit the user to specify input data values.

Hence, although the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A user interface system enabling user selection of related parameters identifying an order for providing an item, comprising:
a repository including information identifying candidate items for order and associated corresponding related order parameters, an individual item for order being associated with a plurality of related order parameters; and
a user interface processor for,
providing data representing a display image identifying an initial complete candidate order including a plurality of related parameters, in response to user entry of order associated data,
in response to user selection of an individual parameter of said initial complete candidate order, providing data representing a plurality of different individually user selectable complete candidate orders incorporating corresponding sets of different related order parameters, said complete candidate orders being derived using said repository and based on user ordering history and
selecting one of said plurality of different individually user selectable complete candidate orders in response to user command.

2. A system according to claim 1, wherein
said initial complete candidate order is a single order and
said orders are orders for providing medical treatment for a patient and said related parameters identify at least one of, (a) quantity, (b) a route of administration of a medical treatment, (c) a frequency of administering a treatment and (d) a form of medical treatment.

3. A system according to claim 2, wherein
said form of medical treatment comprises at least one of, (a) a package type, (b) a strength of a medical treatment and (c) a concentration of a medical treatment.

4. A system according to claim 1, including
a prediction processor for predicting values of remaining parameters of an individual order, in response to user selection of a value of an individual parameter of said initial complete candidate order.

5. A system according to claim 4, wherein
said prediction processor predicts values of remaining parameters related to an individual order based on at least one of, (a) user ordering history and (b) clinical logic.

6. A system according to claim 5, wherein
said clinical logic employs at least one of, (a) Bayesian logic, (b) Hidden Markov Models, (c) neural networks and (d) fuzzy logic.

7. A system according to claim 4, wherein
said prediction processor predicts values of remaining parameters of an individual order in response to a user selected value of a parameter of said individual order and
said user selected value of said parameter of said individual order constrains a set of allowable values of said remaining parameters of said individual order.

8. A system according to claim 1, including
a prediction processor for predicting and incorporating values in said different related order parameters of said plurality of different individually user selectable complete candidate orders, in response to user selection of a value of an individual parameter of said initial complete candidate order.

9. A system according to claim 8, wherein
said prediction processor predicts values of remaining parameters of an individual order based on at least one of, (a) user ordering history and (b) clinical logic.

10. A system according to claim 8, wherein
said prediction processor predicts values of remaining parameters of an individual order in response to a user selected value of a parameter of said individual order and
said user selected value of said parameter of said individual order constrains a set of allowable values of said remaining parameters of said individual order.

11. A system according to claim 1, wherein
said initial complete candidate order is derived by identifying an order having the highest probability of being desired by the user based on user prior ordering history and received medical information of the patient concerned, using said repository.

12. A system according to claim 1, wherein
said initial complete candidate order is derived based on at least one of, (a) predetermined clinical guidelines, (b) predetermined departmental treatment preferences and (c) treatment resource availability.

13. A system according to claim 1, including
a prediction processor for determining a number of said plurality of different individually user selectable complete candidate orders identified in a display image in response to a determined user task load.

14. A system according to claim 1, including
a prediction processor for determining a number of said plurality of different individually user selectable complete candidate orders identified in a display image in response to at least one of, (a) an estimated time required to generate and render an image menu incorporating data identifying said plurality of different individually user selectable complete candidate orders, (b) an estimated number of system interactions required to scroll said image menu incorporating data identifying said plurality of different individually user selectable complete candidate orders and (c) an estimated time required to select and display said image menu incorporating data identifying said plurality of different individually user selectable complete candidate orders.

15. A system according to claim 1, including
a prediction processor for predicting at least one of, (a) said initial complete candidate and (b) said plurality of different individually user selectable complete candidate orders, based on user entered text partially identifying an order.

16. A system according to claim 1, wherein
said user interface processor, in response to user selection of an individual parameter value of said initial complete candidate order, provides data representing a plurality of different individually user selectable partial candidate orders incorporating corresponding sets of different related order parameters, said partial candidate orders being derived using said repository and based on user ordering history and said partial candidate orders, in combination with said user selected individual parameter value, comprise complete candidate orders.

17. A system according to claim 16, including
a prediction processor for predicting values of remaining parameters of said partial candidate orders, said user selected value of said individual parameter remaining fixed.

18. A user interface system enabling user selection of related parameters identifying an order for providing an item, comprising:
a repository including information identifying candidate items for order and associated corresponding related order parameters, an individual item for order being associated with a plurality of related order parameters; and
a user interface processor for,
providing data representing a display image identifying an initial complete candidate order including a plurality of related parameters, in response to user entry of order associated data,
in response to user selection of an individual parameter value of said initial complete candidate order, providing data representing a plurality of different individually user selectable partial candidate orders incorporating corresponding sets of different related order parameters, said partial candidate orders being derived using said repository and based on user ordering history and said partial candidate orders, in combination with said user selected individual parameter value, comprise complete candidate orders and
selecting one of said plurality of different individually user selectable complete candidate orders in response to user command.

19. A system according to claim 18, including
a prediction processor for predicting values of remaining parameters of said partial candidate orders, said user selected value of said individual parameter remaining fixed.
